(19) United States
(12) Patent Application Publication
(10) Pub. No.: US 2004/0114475 A1
(43) Pub. Date: Jun. 17, 2004

(54) Method for playing back record medium

(75) Inventors: Katsuyoshi Suzuki, Tokyo (JP); Hiroshi Orita, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/729,939

(22) Filed: Dec. 9, 2003

(30) Foreign Application Priority Data
Dec. 11, 2002 (JP) 2002-359305

(51) Int. Cl. G11B 7/085

(52) U.S. Cl. 369/30.08

(57) ABSTRACT

In a method for playing back a record medium storing at least a sequence of audio information partitioned into a plurality of segments, prescribed audio information (for alarm sound, silence, etc. for informing the user of the end of each segment) stored in a particular storage area is reproduced when the playback of each segment is finished. After the reproduction of the prescribed audio information, the next segment is played back. By the playback method, it becomes possible to let the user securely perform repeating operation and/or audio switching operation, while decreasing the size of information/data used for informing the user of the end of each segment.

### BACKGROUND OF THE INVENTION

The present invention relates to a record medium storing audio information and a device and method for playing back the record medium.

Record mediums such as CDs and cassette tapes storing audio information for learning have widely been known and used for learning languages such as English conversation, learning techniques for playing musical instruments, etc. Users of such record mediums generally learn their subjects (English conversation, playing the piano, etc.) by using both the record mediums storing audio information and textbooks packed with the record mediums.

In language learning materials (for English conversation, etc.), record mediums (CD, etc.) including at least two areas: a first area storing a sequence of audio information for language learning which is partitioned into a plurality of segments; and a second area storing a sequence of audio information for comment or explanation corresponding to the segmented language learning audio information sequence, have become widespread, and playback methods and switching playback methods for such record mediums have been well known as disclosed in, for example, Japanese Patent No.2983194 (claims 4 and 5, FIG. 1).

The above patent document proposes a record medium, a method for playing back the record medium, and a method for handling interrupts during audio playback in order to realize secure repeat playback when the user could not hear or comprehend a sentence well and needs to listen to the sentence again.

The interrupt handling method disclosed in the document employs a judgment on whether an interrupt request occurred in the first half or in the second half of the segment being played back. When the interrupt request is judged to have occurred in the first half of a segment #n being replayed, the immediately preceding segment #n−1 is designated as the target segment for the interrupt. Meanwhile, when the interrupt request is judged to have occurred in the second half of the segment #n being replayed, the segment #n itself is designated as the target segment for the interrupt. Therefore, if the switching operation for switching the playback area from the English area to the Japanese (comment or explanation) area is done by the user during the playback in the first half of the segment #n storing English voice information in the hope of listening to a corresponding Japanese translation, a Japanese translation corresponding to the previous English segment #n−1 is played back and the user might misunderstand the meaning of English sentences.

Further, even if the switching playback method is configured to necessarily play back a corresponding Japanese segment #n when the switching is done during the playback of the English segment #n, the user hoping to listen to a corresponding Japanese sentence after hearing an English sentence has to do the switching operation quickly (late switching operation causes playback of Japanese segment #n+1), by which the user's attention is often distracted from the English voice to the switching operation, causing frustration of the user who is incapable of concentrating on learning.

FIG. 1 is a schematic diagram showing another type of record medium. A track A is composed of segments storing English voice information, and a track B is composed of segments storing Japanese translations of the English voice stored in corresponding segments of the track A. When the record medium is played back, the audio (voice) information on the track A is successively reproduced or played starting from a segment #1. When the playback mode is switched, audio information stored in a segment of the track B corresponding to the segment of the track A being played back will be reproduced. For example, if the playback mode is switched when the segment #3 of the track A is replayed, then a segment #3 of the track B is played back. In short, the English voice information in the track A and the Japanese voice information in the track B are stored so that segments of the same segment number correspond to each other. The thick line at the end of each segment shown in FIG. 1 denotes an “alarm sound”. The alarm sound means a sound for informing the user of the end of each segment, being reproduced at the end of each English/Japanese sentence. By such composition of the record medium, the user who finished listening to each sentence can recognize the end of each segment by the alarm sound. Therefore, when the user has listened to an English sentence and wants to listen to a corresponding Japanese sentence, the user is allowed to listen to the desired Japanese sentence by the secure playback mode switching operation.

In the above record medium, however, the alarm sound information is stored in each segment, by which the amount of English/Japanese voice information for learning that can be stored in the record medium is necessitated to be reduced. Users prefer that each record medium should store the English/Japanese learning voice information as much as possible for the sake of cost reduction and easy management of record mediums. Therefore, the size of information or data (alarm sound, etc.) used for informing the user of the end of each segment should be as small as possible.

### SUMMARY OF THE INVENTION

It is therefore the primary object of the present invention to provide a record medium, a playback device, and a method for playing back the record medium, capable of letting the user securely perform the repeating operation and/or the audio switching operation, while decreasing the size of information/data used for informing the user of the end of each segment.

In accordance with a first aspect of the present invention, there is provided a method for playing back a record medium storing at least a sequence of audio information partitioned into a plurality of segments, comprising the steps of: reproducing audio information stored in each segment of the audio information sequence; and reproducing prescribed audio information stored in a particular storage area for informing the user of an end of each segment before the playback of a next segment is started.

In the playback method, the particular storage area may either be a prescribed area of the record medium or a prescribed storage area of a playback device which plays back the record medium.

In the playback method, the prescribed audio information may either be audio information of an alarm sound or blank audio information for silence.

Preferably, the playback method further comprises the steps of: detecting a switching operation requesting switching of audio information sequence to be played back; and reproducing audio information stored in a segment of another audio information sequence corresponding to the segment being played back if the switching operation is received before the playback of the next segment.

In accordance with another aspect of the present invention, there is provided a method for playing back a record medium storing at least a sequence of audio information partitioned into a plurality of segments, comprising the steps of: reproducing audio information stored in each segment of the audio information sequence; and displaying prescribed image information for informing a user of approaching an end of the segment before the playback of a next segment is started. Preferably, the display of the prescribed image information is started when remaining playback time of the segment being played back decreased to a preset time length.

Preferably, the display of the prescribed image information is cleared when the playback of the next segment is started.

In the playback method, the prescribed image information may either be image information of a counter which varies depending on the remaining playback time of the segment or lighting/blinking of one or more light emitting modules which varies depending on the remaining playback time of the segment.

In accordance with another aspect of the present invention, there is provided a record medium storing at least a sequence of audio information partitioned into a plurality of segments, comprising a particular area storing prescribed audio information to be reproduced for informing the user of an end of each segment before the playback of a next segment is started.

In the record medium, the prescribed audio information may either be audio information of an alarm sound or blank audio information for silence.

In accordance with another aspect of the present invention, there is provided a playback device for playing back a record medium storing at least a sequence of audio information partitioned into a plurality of segments, comprising: an audio information reproduction module which reproduces audio information stored in each segment of the audio information sequence; and a prescribed audio information reproduction module which reproduces prescribed audio information stored in a particular storage area for informing the user of an end of each segment before the playback of a next segment is started by the audio information reproduction module.

Preferably, the playback device further comprises a storage module having the particular storage area for storing the prescribed audio information.

Preferably, the playback device further comprises: a switching operation reception module which receives a switching operation requesting switching of an audio information sequence to be played back; a switching module which switches the audio information sequence to be played back when the switching operation reception module received the switching operation; a position storage module which stores the position of playback before the switching of the audio information sequence; a control module which determines a segment to be played back based on the position stored in the position storage module and the audio information sequence switched by the switching module.

Preferably, the audio information reproduction module reproduces audio information stored in a segment of another audio information sequence corresponding to the segment being played back if the switching operation is received by the switching operation reception module before the playback of the next segment.

In the playback device, the prescribed audio information may either be audio information of an alarm sound or blank audio information for silence.

In accordance with another aspect of the present invention, there is provided a playback device for playing back a record medium storing at least a sequence of audio information partitioned into a plurality of segments, comprising: an audio information reproduction module which reproduces audio information stored in each segment of the audio information sequence; a storage module which stores prescribed image information for informing the user of approaching an end of each segment; a display module which displays the prescribed image information; a control module which controls the display module to display the prescribed image information before the playback of a next segment is started. Preferably, the control module controls the display module to start the display of the prescribed image information when remaining playback time of the segment being played back decreased to a preset time length.

Preferably, the control module clears the display of the prescribed image information when the playback of the next segment is started.

In the playback device, the prescribed image information may either be image information of a counter which varies depending on the remaining playback time of the segment or lighting/blinking of one or more light emitting modules which varies depending on the remaining playback time of the segment.

In accordance with another aspect of the present invention, there is provided a program for instructing a computer, microprocessor unit, etc. to execute a process for playing back a record medium storing at least a sequence of audio information partitioned into a plurality of segments. The playback process comprises the steps of: reproducing audio information stored in each segment of said audio information sequence; and reproducing prescribed audio information stored in a particular storage area for informing a user of an end of each segment before the playback of a next segment is started.

In accordance with another aspect of the present invention, there is provided a program for instructing a computer, microprocessor unit, etc. to execute a process for playing back a record medium storing at least a sequence of audio information partitioned into a plurality of segments. The playback process comprises the steps of: reproducing audio information stored in each segment of said audio information sequence; and displaying prescribed image information for informing a user of approaching an end of the segment before the playback of a next segment is started.

### BRIEF DESCRIPTION OF THE ACCOMPANYING DRAWINGS

The objects and features of the present invention will become more apparent from the consideration of the following detailed description taken in conjunction with the accompanying drawings, in which:

FIG. 1 is a schematic diagram for explaining an example of audio information stored in a conventional record medium;

FIG. 2 is a block diagram showing the composition of an information playback device and a record medium in accordance with a first embodiment of the present invention;

FIG. 3 is a schematic diagram for explaining information stored in the record medium of the first embodiment;

FIG. 4 is a flow chart showing an audio information reproduction process for the record medium executed by the information playback device of the first embodiment;

FIG. 5 is a flow chart showing an interrupt process for mode switching according to the first embodiment;

FIG. 6 is a flow chart showing the interrupt process for repeat reproduction according to the first embodiment;

FIG. 7 is a schematic diagram for explaining information stored in a record medium in accordance with a second embodiment of the present invention;

FIG. 8 is a flow chart showing an audio information reproduction process for the record medium executed by an information playback device of the second embodiment;

FIG. 9 is a block diagram showing the composition of an information playback device in accordance with a third embodiment of the present invention;

FIG. 10 is a schematic diagram showing an example of image information displayed by a display section of the information playback device of the third embodiment; and

FIG. 11 is a flow chart showing an audio information reproduction process for the record medium executed by the information playback device of the third embodiment.

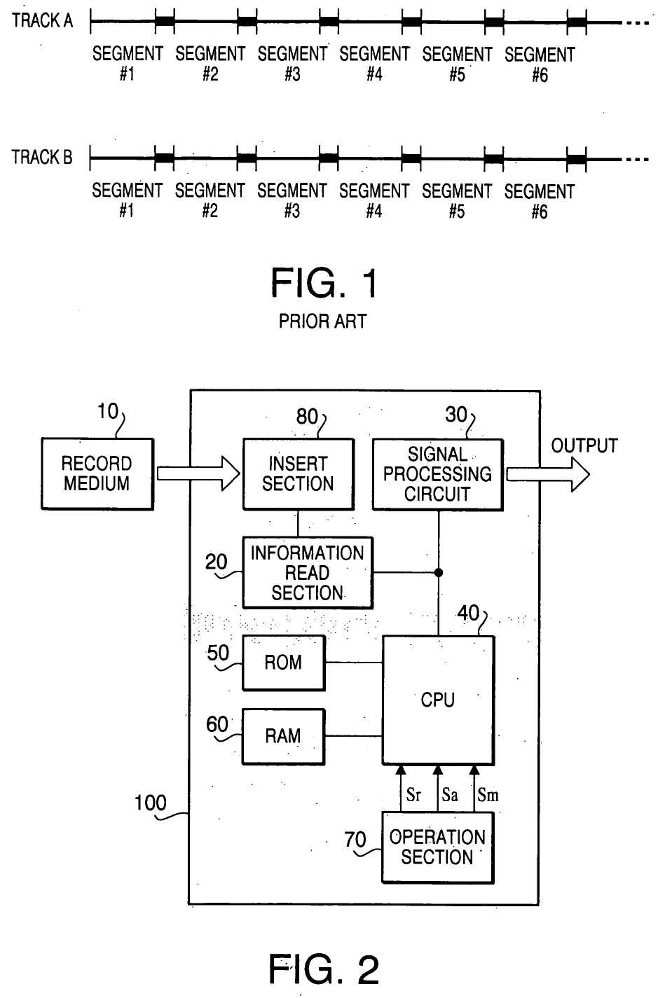

### DETAILED DESCRIPTION OF THE EMBODIMENTS

Referring now to the drawings, a description will be given in detail of preferred embodiments in accordance with the present invention.

FIG. 2 is a block diagram showing the composition of an information playback device 100 and a record medium 10 in accordance with a first embodiment of the present invention. The record medium 10 is a storage medium for storing audio information for language learning, for example. The information playback device 100 shown in FIG. 2 includes an insert section 80 to which the record medium 10 is inserted and set, an information read section 20 for reading out information from the record medium 10, a signal processing circuit 30 for processing the information read by the information read section 20 and thereby outputting an audio signal, a CPU (Central Processing Unit) 40 for controlling the whole information playback device 100, ROM 50 for storing a variety of information for the operation of the information playback device 100, RAM 60 for temporarily storing information, and an operation section 70 which is provided for letting the user operate the information playback device 100.

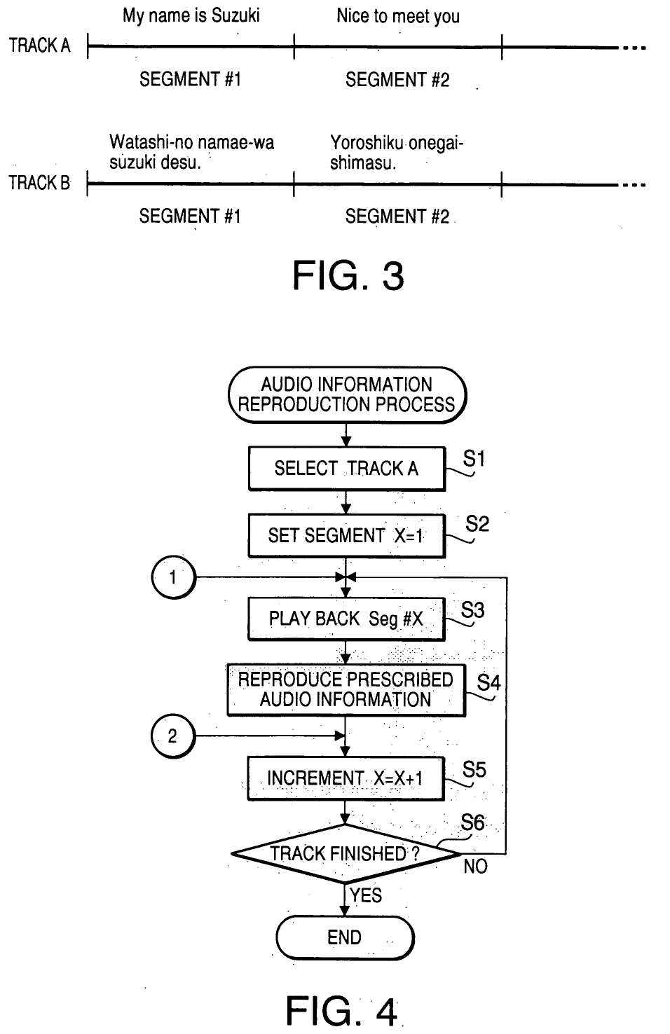

FIG. 3 is a schematic diagram for explaining information stored in the record medium 10 of the first embodiment. The record medium 10 stores two audio information sequences (hereafter, referred to as “tracks”): track A and track B. The record medium 10 may be implemented by various mediums such as CD-ROM, magnetic recording medium and nonvolatile memory.

The track A of the record medium 10 includes n segments storing audio information (English voice) for learning English, and the track B includes n segments each of which stores Japanese translation (Japanese voice) of the English voice stored in a corresponding segment of the track A. Since the record medium 10 is a learning material for English learners, the track A storing the English voice information is defined as “main track” and the track B storing the Japanese voice information is defined as “sub track”. This means that the track A is played back first at the start of the playback of the record medium 10.

When the record medium 10 is played back, the audio (voice) information on the track A is successively reproduced starting from a segment #1. When the track is switched from the track A to the track B, audio information stored in a segment of the track B corresponding to the segment of the track A being played back will be reproduced. For example, if the track is switched when the segment #2 of the track A is being replayed, then a segment #2 of the track B is played back. In short, the English voice information in the track A and the Japanese voice information in the track B are stored so that segments of the same segment number correspond to each other. Incidentally, while the tracks A and B are drawn separately in FIG. 3 for the sake of clear understanding of this embodiment, on an actual record medium 10, the segments of the tracks A and B are recorded alternately in ascending order of the segment number as: segment #1 (track A), segment #1 (track B), segment #2 (track A), segment #2 (track B) . . . .

The information read section 20 is a module for reading information stored in the record medium 10. In cases where the record medium 10 is a CD-ROM or a magnetic recording medium, the information read section 20 is implemented by a pick up device for detecting information recorded on the recording surface of the medium. In cases where the record medium 10 is nonvolatile memory, the information read section 20 is implemented by a device for electrically reading information stored in the memory and sending a corresponding signal to the signal processing circuit 30.

The signal processing circuit 30 receives a digital audio signal from the information read section 20, processes the signal by a prescribed signal processing method, and outputs generated analog audio signal to an unshown external device such as speakers.

The ROM 50 is implemented by non-rewritable mask ROM or electrically rewritable flash ROM, in which a variety of information for the operation of the information playback device 100 is stored. The information stored in the ROM 50 includes audio information for letting the user know the end of each segment (which will be explained in detail later), an audio reproduction program for playing back the record medium 10, etc.

The RAM 60 is memory for temporarily storing information or data such as the address of a segment to be played back.

The operation section 70 has a plurality of keys to be pressed for operating the information playback device 100. Various signals corresponding to the key entry by the user is outputted by the operation section 70 to the CPU 40 as input signals. The input signals include a playback signal for starting the playback of the record medium 10, a repeat signal Sr (shown in FIG. 2), a mode switching signal Sm (shown in FIG. 2), an alarm sound switching signal Sa (shown in FIG. 2), etc. The repeat signal Sr is an input signal for instructing the CPU 40 to repeat the segment being replayed. The mode switching signal Sm is an input signal for instructing the CPU 40 to switch the track being replayed between the track A and track B. The alarm sound switching signal Sa is an input signal for changing audio information (alarm sound) used for informing the user of the end of each segment, depending on the preference of the user. The details of the audio information for the alarm sound will be described later.

FIG. 4 is a flow chart showing an audio information reproduction process for the record medium 10 which is executed by the information playback device 100 of the first embodiment. In the following, the audio information reproduction process will be explained in detail referring to FIG. 4.

First, the user sets the record medium 10 (CD-ROM, magnetic recording medium, nonvolatile memory, etc.) in the insert section 80, activates the information playback device 100 by pressing a power key of the operation section 70, and starts replaying the record medium 10 by pressing a playback key. Since the track A storing the English voice information is the main track and the track B storing the Japanese voice information is the sub track as mentioned before, the track A is automatically selected as the track to be replayed (hereafter, referred to as “replay track”) (S1).

After the selection of the replay track, a start segment (at which the playback should be started) is set (S2). Here, to “set” the start segment means writing the address of the start segment into the RAM 60. In this example, an address “1” of Seg #1 (segment #1) is written into the RAM 60 as “segment address X”. Incidentally, when a stop signal for stopping the playback of the record medium 10 is inputted to the CPU 40, the reproduction process is stopped and the address of Seg #X (which had been replayed at the point when the stop signal was inputted) is written into the RAM 60. When the reproduction process is restarted, the process directly proceeds to step S3 without executing the step S2 since the address of the start segment Seg#X has already been stored in the RAM 60. In this embodiment, however, the address of Seg #X stored in the RAM 60 is erased when power is shut off, therefore, the process starts from the step S1 when the power is turned on again and the reproduction process is restarted.

Meanwhile, by configuring another embodiment to write the address of Seg #X into unshown nonvolatile memory such as EEPROM (Electrically Erasable Programmable ROM) or flash memory, the address can be maintained even if the power is shut off, that is, the resume function can be provided to the information playback device 100.

After writing the address of the start segment Seg #X in the RAM 60, reproduction of the audio information stored in Seg #X is carried out based on the address (S3).

When the reproduction of the audio information of Seg #X is finished, the audio reproduction program reads prescribed audio information (for informing the user of the end of Seg #X which has been played back) from the ROM 50 and reproduces the audio information (S4). The prescribed audio information may be blank audio information for silence (silent time period), or audio information for an alarm sound for actively informing the user of the end of segment. Various alarm sounds of different patterns and lengths are previously stored in the ROM 50, and the user is allowed to select a desired alarm sound (or silence) and register it with the information playback device 100 by operating the operation section 70.

After the reproduction of the prescribed audio information, the audio reproduction program increments the segment address X stored in the RAM 60 by 1, that is, the address of the next segment Seg #X+1 is written into the RAM 60 as a new segment address X (S5).

As mentioned before, the track A includes n segments, therefore, when the incremented new segment address X is larger than the number n of segments stored in the track A, the playback of track A is judged to have finished (YES in S6) and the audio information reproduction process for the record medium 10 is ended.

Meanwhile, when the incremented new segment address X is n or less, the playback of track A is judged to have not finished yet (NO in S6) and the process is returned to the step S3 to continue the audio information reproduction process for the record medium 10.

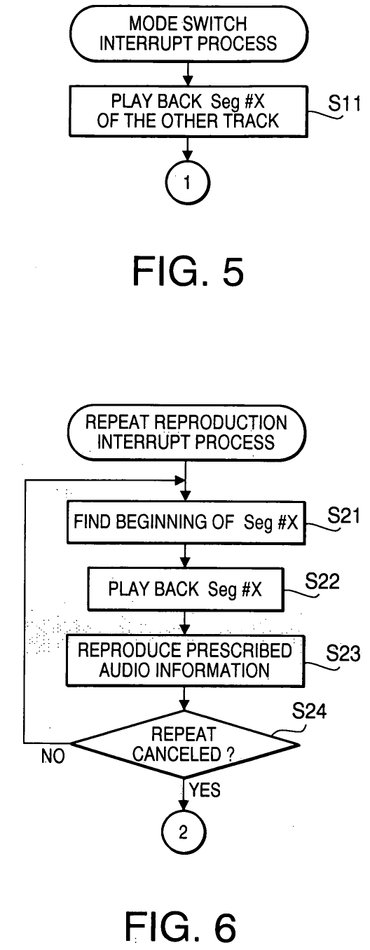

Next, an interrupt process which is executed when the user switches the playback mode in order to listen to Japanese translation of the English voice being played back will be explained in detail. FIG. 5 is a flow chart showing the interrupt process for the mode switching according to the first embodiment.

When the user presses a “mode key” of the operation section 70 (for switching the replay track) during the playback of the track A or track B, the mode switching signal Sm is outputted by the operation section 70 to the CPU 40, by which the interrupt process for mode switching is started. For example, if the mode key is pressed during the playback of the track A, the audio reproduction program refers to the segment address X (of the segment Seg #X of the track A being played back) stored in the RAM 60, jumps to an address of Seg#X of the track B that corresponds to the segment address X, and reproduces audio information from the address (S11).

When the playback of Seg #X of the track B is finished, the process returns to the step S3 of FIG. 4, by which the ordinary audio information reproduction process is continued by playing back Seg #X of the track A. If the mode key is pressed during the playback of the track B, the interrupt process is ended and the process is returned to the step S3 of FIG. 4, by which the ordinary audio information reproduction process is continued by playing back Seg #X of the track A.

While the audio reproduction program of the above embodiment directly returns to the original segment of the track A when the playback of the corresponding segment of the track B (storing a Japanese translation) is finished, the audio reproduction program may also reproduce the prescribed audio information stored in the ROM 50 (alarm sound or silence) before returning to the original segment of the track A.

Next, an interrupt process which is executed when the user hopes to repeat a segment being replayed will be explained in detail. FIG. 6 is a flow chart showing the interrupt process for the repeat reproduction according to the first embodiment.

When the user presses a “repeat key” of the operation section 70 (for repeating the replayed segment) during the playback of the track A, the repeat signal Sr is outputted by the operation section 70 to the CPU 40, by which the interrupt process for repeat reproduction is started. Incidentally, pressing the repeat key once during the ordinary reproduction process activates the interrupt process for repeat reproduction, while pressing the repeat key once during the repeat reproduction interrupt process cancels the interrupt process.

When the interrupt process is started, the CPU 40 (audio reproduction program) finds the beginning of the segment Seg #X being replayed (that is, returns to the front end of Seg #X) (S21), plays back Seg #X from its beginning (S22), and reproduces the prescribed audio information stored in the ROM 50 (S23).

After the reproduction of the prescribed audio information, the CPU 40 judges whether or not the repeat reproduction interrupt process has been canceled, that is, whether or not the repeat key has been pressed during the steps S21-S23 (S24). If the interrupt process has been canceled (YES in S24), the process is returned to the step S5 of FIG. 4, by which the segment address X stored in the RAM 60 is incremented by 1 and the ordinary audio information reproduction process is continued.

Meanwhile, if the interrupt process has not been cancelled (NO in S24), the process is returned to the step S21 and the repeat reproduction interrupt process is continued (Seg #X is played back again).

As described above, by the record medium and the device and method for playing back the record medium in accordance with the first embodiment of the present invention, the prescribed audio information (for alarm sound or silence) for informing the user of the end of the currently replayed segment (sentence, etc.), which has been stored in the ROM 50 of the information playback device 100 (particular storage area), is reproduced when the playback of each segment is finished. Therefore, the need of storing the prescribed audio information in each segment of the record medium is eliminated and the amount of audio information stored in each record medium can be increased while letting the user securely perform the repeating operation and the audio switching operation. Incidentally, while the prescribed audio information was reproduced in the above embodiment after the playback of the currently replayed segment is finished, it is also possible to reproduce the prescribed audio information (alarm sound, jingle, etc.) so as to overlap with the ending of the currently replayed segment.

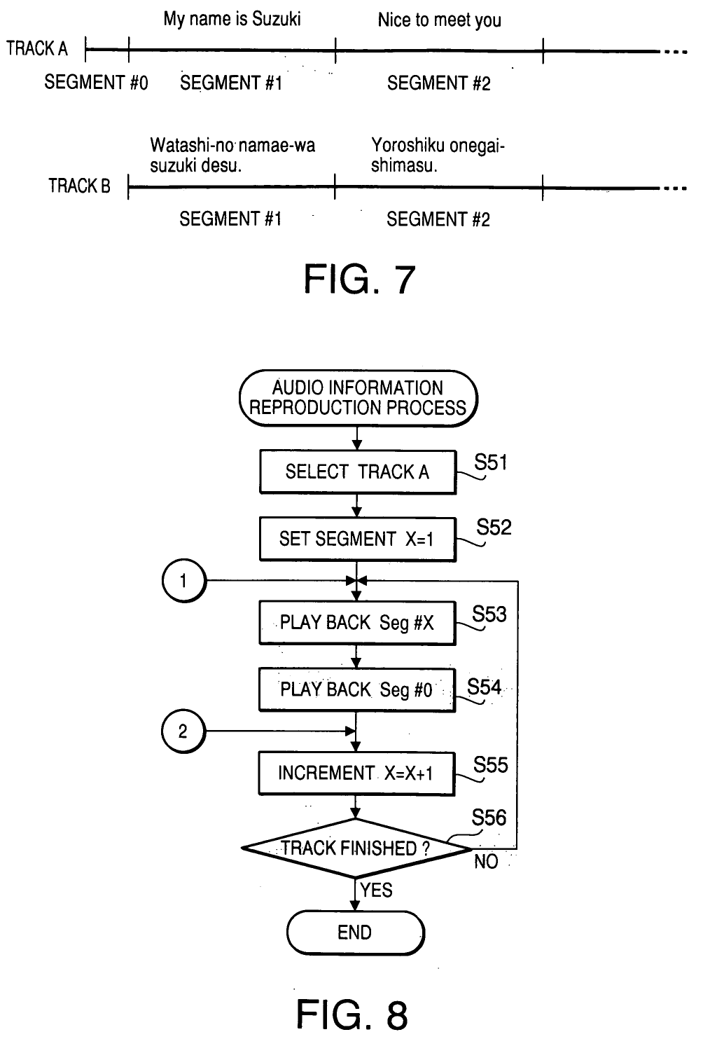

FIG. 7 is a schematic diagram for explaining information stored in a record medium 10z in accordance with a second embodiment of the present invention. The record medium 10z stores two tracks (audio information sequences): track A and track B. The record medium 10z maybe implemented by various mediums such as CD-ROM, magnetic recording medium and nonvolatile memory.

The track A of the record medium 10z includes n segments storing audio information (English voice) for learning English, and the track B includes n segments each of which stores Japanese translation (Japanese voice) of the English voice stored in a corresponding segment of the track A. The track A further includes a segment Seg #0 which stores prescribed audio information for letting the user know the end of each segment Seg #X which has been played back. The prescribed audio information stored in Seg #0 may be blank audio information for silence (silent time period), or audio information for an alarm sound for actively informing the user of the end of segment. Also in the record medium 10z, the track A is defined as the main track and the track B is defined as the sub track, and the English voice information in the track A and the Japanese voice information in the track B are stored so that segments of the same segment number correspond to each other.

FIG. 8 is a flow chart showing an audio information reproduction process for the record medium 10z which is executed by an information playback device 100 of the second embodiment. In the following, the audio information reproduction process will be explained in detail referring to FIG. 8.

First, the user sets the record medium 10z (CD-ROM, magnetic recording medium, nonvolatile memory, etc.) in the insert section 80, turns the power on, and starts replaying the record medium 10z by pressing the playback key. Similarly to the first embodiment, the audio reproduction program of the second embodiment automatically selects the track A as the replay track (S51), writes a starting segment address (address of Seg #1) to the RAM 60 (S52), and reproduces the audio information stored in Seg #X (initially, Seg #1) based on the address written in the RAM 60 (S53).

When the reproduction of the audio information of Seg #X is finished, the audio reproduction program jumps to the address of Seg #0 at the front end of the track A, reads the prescribed audio information (for informing the user of the end of Seg #X which has been played back) from Seg #0, and reproduces the audio information (S54). Incidentally, while Seg #0 for storing the prescribed audio information is placed at the front end of the track A in this embodiment, Seg #0 can be formed in any area of the record medium 10z.

After the reproduction of the prescribed audio information stored in Seg #0, the audio reproduction program increments the segment address X stored in the RAM 60 by 1 similarly to the first embodiment (S55), carries out the track end judgment process like that of the first embodiment (S56), and continues (NO in S56) or ends (YES in S56) the audio information reproduction process for the record medium 10z depending on the judgment. The mode switching interrupt process and the repeat reproduction interrupt process are executed in the same way as those of the first embodiment.

As described above, by the record medium and the device and method for playing back the record medium in accordance with the second embodiment of the present invention, the prescribed audio information (for alarm sound or silence) for informing the user of the end of the currently replayed segment (sentence, etc.), which has been stored in Seg #0 of the record medium 10z (particular storage area), is reproduced when the playback of each segment is finished. Therefore, the need of storing the prescribed audio information in each segment of the record medium is eliminated and the amount of audio information stored in each record medium can be increased while letting the user securely perform the repeating operation and the audio switching operation. The effects of the record medium of the second embodiment become remarkable when the number of segments in a track is 3 or more.

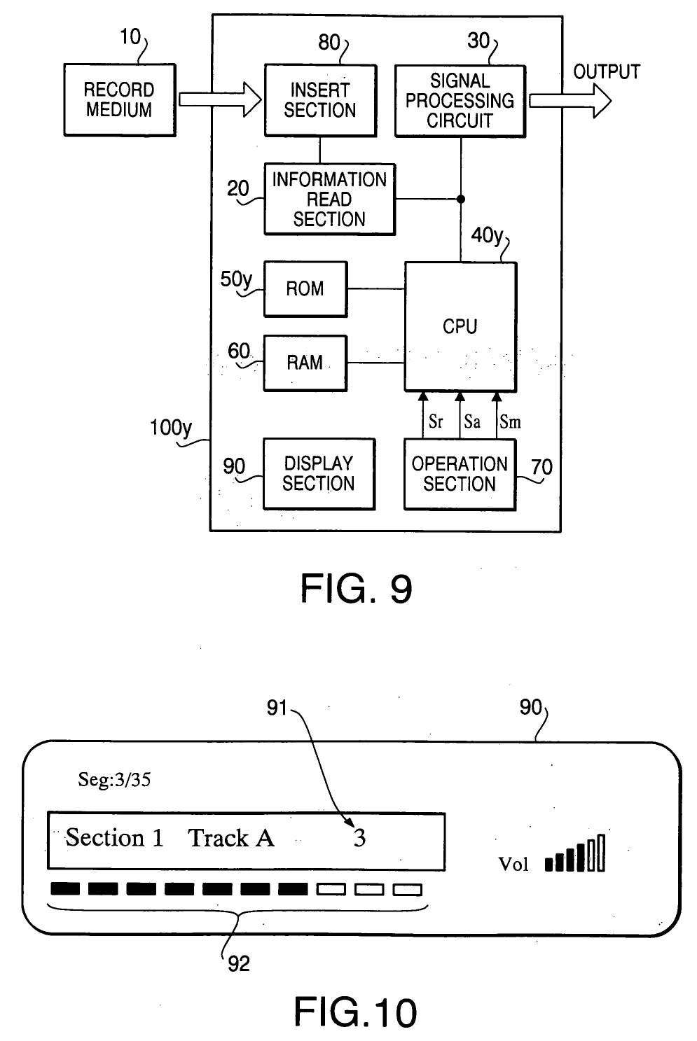

FIG. 9 is a block diagram showing the composition of an information playback device 100y in accordance with a third embodiment of the present invention, wherein elements already shown in FIG. 2 (first embodiment) are indicated with the same reference characters and repeated description thereof is omitted for brevity.

The information playback device 100y shown in FIG. 9 includes an information read section 20, a signal processing circuit 30, a CPU 40y for controlling the whole information playback device 100y, ROM 50y for storing a variety of information for the operation of the information playback device 100y, RAM 60, an operation section 70, an insert section 80, and a display section 90 for displaying the playback status of the record medium 10.

FIG. 10 is a schematic diagram showing an example of image information displayed by the display section 90. In addition to sound volume and track/segment numbers regarding the segment being replayed, the display section 90 displays prescribed image information (indicating that the segment is about to end) when remaining playback time of the replayed segment has become a preset time length or less. The prescribed image information may be a counter 91 and a progress bar 92 which are shown in FIG. 10. The counter 91 and progress bar 92, which appear on the display section 90 when the remaining playback time of the replayed segment decreased to the preset time length and change their appearance depending on the remaining segment playback time, are displayed by using image information stored in the ROM 50y.

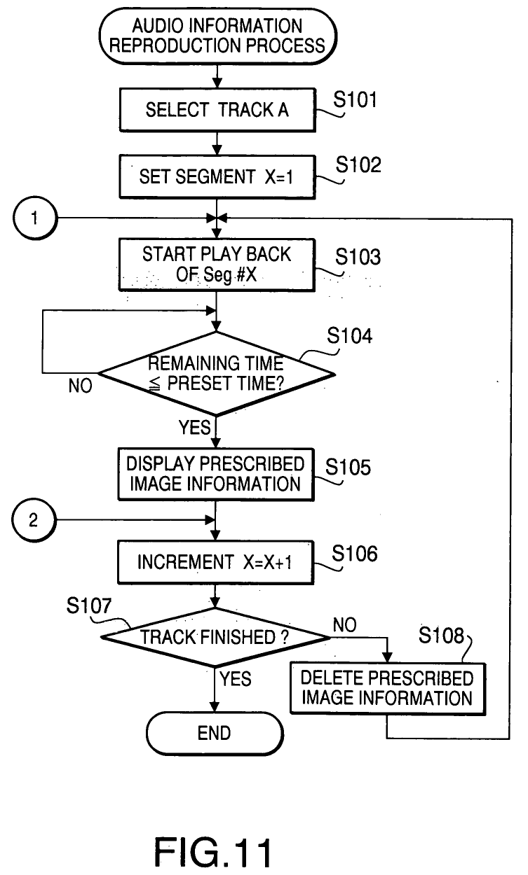

FIG. 11 is a flow chart showing an audio information reproduction process for the record medium 10 which is executed by the information playback device 100y of the third embodiment. In the following, the audio information reproduction process will be explained in detail referring to FIG. 11.

First, the user sets the record medium 10 (CD-ROM, magnetic recording medium, nonvolatile memory, etc.) in the information playback device 100y, turns the power on, and starts replaying the record medium 10 by pressing the playback key. Similarly to the first embodiment, the audio reproduction program of the third embodiment automatically selects the track A as the replay track (S101), writes the starting segment address (address of Seg #1) to the RAM 60 (S102), and reproduces the audio information stored in Seg #X (initially, Seg #1) based on the address written in the RAM 60 (S103).

When the playback of Seg #X is started, the CPU 40y activates an unshown time checking circuit/routine for checking the remaining playback time of Seg #X in parallel with the playback of Seg #X (S104). If the time checking circuit judges that the remaining playback time is a preset time length or less (YES in S104), the audio reproduction program displays the aforementioned prescribed image information stored in the ROM 50y on the display section 90 in sync with the audio information being reproduced (S105).

In the case where the prescribed image information is the counter 91, the counter 91 is displayed on the display section 90 and starts counting down when the remaining playback time of Seg #X decreased to the preset time length, so that “0” will be displayed at the end of the playback of Seg #X. It is also possible to let the counter 91 display “0” just before the end of the playback of Seg #X, and reproduce audio information such as the blank audio information between the “0” and the end of the playback of Seg #X.

In the case where the prescribed image information is the progress bar 92, bar segments of the progress bar 92 starts changing from white to black from the leftmost segment when the remaining playback time of Seg #X decreased to the preset time length, so that all the bar segments will be black at the end of the playback of Seg #X. It is also possible to inform the user that the end of segment is approaching by blinking the progress bar 92 or an unshown LED with varying (shortening, for example) blink cycle. When the display section 90 is capable of displaying colors, the color of the progress bar 92 may be changed for informing the user that the segment is about to end. The operation section 70 has a selection key for letting the user select or switch the prescribed image information according to preference.

When the playback of Seg #X is finished, the audio reproduction program increments the segment address X stored in the RAM 60 by 1 similarly to the first embodiment (S106), carries out the track end judgment process like that of the first embodiment (S107), and continues (NO in S107) or ends (YES in S107) the audio information reproduction process for the record medium 10 depending on the judgment. In the case where the audio information reproduction process is continued, the audio reproduction program clears the prescribed image information from the display section 90 (S108) and reproduces audio information of the next segment. The mode switching interrupt process and the repeat reproduction interrupt process are executed in the same way as those of the first embodiment.

As another example of the third embodiment, it is also possible to start displaying the prescribed image information (counter 91, progress bar 92, etc.) at a time point when a preset time has passed since the start of the playback of Seg #X. In this example, the audio reproduction program is programmed to monitor playback time of the currently replayed segment and inform the user of approaching end of the segment by displaying or blinking the progress bar 92 or LED during a time period between the time point and the end of the current segment.

As still another example of the third embodiment, the prescribed image information may be displayed depending on playback start time of the next segment, that is, the display of the prescribed image information may be started at a time point when remaining playback time till the start time of the next segment is decreased to a preset time length. In this example, the audio reproduction program is programmed to constantly check playback time of the currently replayed segment and the playback start time of the next segment and inform the user of approaching end of the segment by displaying or blinking the progress bar 92 or LED during a time period between the time point and the end of the current segment.

As described above, by the record medium and the device and method for playing back the record medium in accordance with the third embodiment of the present invention, the prescribed image information for informing the user of approaching end of the currently replayed segment (sentence, etc.) is displayed when the playback of each segment is finished. Therefore, the need of storing audio information (for alarm sound or silence) in each segment of the record medium is eliminated and the amount of audio information stored in each record medium can be increased while letting the user visually and clearly recognize the end of each segment and securely perform the repeating operation and the audio switching operation.

While the present invention has been described with reference to the particular illustrative embodiments, it is not to be restricted by those embodiments but only by the appended claims. For example, while the description of the above embodiment was given assuming a record medium for language learning (having the track A storing English voice information and the track B storing Japanese voice information, for example), the present invention is also applicable to various record mediums for a diversity of purposes, such as record mediums used for learning techniques for playing musical instruments (having a track A storing audio information of piano sound and a track B storing audio information of comments, for example). It is to be appreciated that those skilled in the art can change or modify the embodiments without departing from the scope and spirit of the present invention.

The present disclosure relates to the subject matter contained in Japanese Patent Application No. P2002-359305, filed on Dec. 11, 2002, which is expressly incorporated herein by reference in its entirety.

What is claimed is:

1. A method for playing back a record medium storing at least a sequence of audio information partitioned into a plurality of segments, comprising:
reproducing audio information stored in each segment of said audio information sequence; and
reproducing prescribed audio information stored in a particular storage area for informing a user of an end of each segment before the playback of a next segment is started.

2. The method according to claim 1, wherein said particular storage area is a prescribed area of said record medium.

3. The method according to claim 1, wherein said particular storage area is a prescribed storage area of a playback device which plays back said record medium.

4. The method according to claim 1, wherein said prescribed audio information is audio information of an alarm sound.

5. The method according to claim 1, wherein said prescribed audio information is blank audio information for silence.

6. The method according to claim 1, further comprising:
detecting a switching operation requesting switching of audio information sequence to be played back; and
reproducing audio information stored in a segment of another audio information sequence corresponding to the segment being played back if the switching operation is received before the playback of the next segment.

7. A method for playing back a record medium storing at least a sequence of audio information partitioned into a plurality of segments, comprising:
reproducing audio information stored in each segment of said audio information sequence; and
displaying prescribed image information for informing a user of approaching an end of the segment before the playback of a next segment is started.

8. The method according to claim 7, wherein the display of said prescribed image information is started when remaining playback time of the segment being played back decreased to a preset time length.

9. The method according to claim 7, wherein the display of said prescribed image information is cleared when the playback of the next segment is started.

10. The method according to claim 7, wherein said prescribed image information is image information of a counter which varies depending on the remaining playback time of the segment.

11. The method according to claim 7, wherein said prescribed image information is lighting/blinking of one or more light emitting modules which varies depending on the remaining playback time of the segment.

12. The method according to claim 7, further comprising:
detecting a switching operation requesting switching of audio information sequence to be played back; and
reproducing audio information stored in a segment of another audio information sequence corresponding to the segment being played back if the switching operation is received before the playback of a next segment.

13. A record medium storing at least a sequence of audio information partitioned into a plurality of segments, comprising:
a particular area storing prescribed audio information to be reproduced for informing a user of an end of each segment before the playback of a next segment is started.

14. The record medium according to claim 13, wherein said prescribed audio information is audio information of alarm sound.

15. The record medium according to claim 13, wherein said prescribed audio information is blank audio information for silence.

16. A playback device for playing back a record medium storing at least a sequence of audio information partitioned into a plurality of segments, comprising:
an audio information reproduction module which reproduces audio information stored in each segment of said audio information sequence; and
a prescribed audio information reproduction module which reproduces prescribed audio information stored in a particular storage area for informing a user of an end of each segment before the playback of a next segment is started by said audio information reproduction module.

17. The playback device according to claim 16, further comprising a storage module having said particular storage area for storing said prescribed audio information.

18. The playback device according to claim 16, further comprising:
a switching operation reception module which receives a switching operation requesting switching of audio information sequence to be played back;
a switching module which switches the audio information sequence to be played back when said switching operation reception module received the switching operation;
a position storage module which stores the position of playback before the switching of the audio information sequence;
a control module which determines a segment to be played back based on the position stored in the position storage module and the audio information sequence switched by said switching module.

19. The playback device according to claim 18, wherein said audio information reproduction module reproduces audio information stored in a segment of another audio information sequence corresponding to the segment being played back if the switching operation is received by said switching operation reception module before the playback of the next segment.

20. The playback device according to claim 16, wherein said prescribed audio information is audio information of alarm sound.

21. The playback device according to claim 16, wherein said prescribed audio information is blank audio information for silence.

22. A playback device for playing back a record medium storing at least a sequence of audio information partitioned into a plurality of segments, comprising:
an audio information reproduction module which reproduces audio information stored in each segment of said audio information sequence;
a storage module which stores prescribed image information for informing a user of approaching an end of each segment;
a display module which displays said prescribed image information;
a control module which controls said display module to display said prescribed image information before the playback of a next segment is started.

23. The playback device according to claim 22, wherein said control module controls said display module to start the display of said prescribed image information when remaining playback time of the segment being played back decreased to a preset time length.

24. The playback device according to claim 22, wherein said control module clears the display of said prescribed image information when the playback of the next segment is started.

25. The playback device according to claim 22, wherein said prescribed image information is image information of a counter which varies depending on the remaining playback time of the segment.

26. The playback device according to claim 22, further comprising one or more light emitting modules which light/blink based on said prescribed image information.

27. The playback device according to claim 22, wherein said audio information reproduction module reproduces audio information stored in a segment of another audio information sequence corresponding to the segment being played back if a switching operation requesting switching of audio information sequence to be played back is received before the playback of the next segment.

28. A Computer program product for instructing a computer, microprocessor unit, etc. to execute a process for playing back a record medium storing at least a sequence of audio information partitioned into a plurality of segments, wherein the playback process comprises the steps of:
reproducing audio information stored in each segment of said audio information sequence; and
reproducing prescribed audio information stored in a particular storage area for informing a user of an end of each segment before the playback of a next segment is started.

29. A Computer program product for instructing a computer, microprocessor unit, etc. to execute a process for playing back a record medium storing at least a sequence of audio information partitioned into a plurality of segments, wherein the playback process comprises the steps of:
reproducing audio information stored in each segment of said audio information sequence; and
displaying prescribed image information for informing a user of approaching an end of the segment before the playback of a next segment is started.
